(19) United States
(12) Patent Application Publication
(10) Pub. No.: US 2019/0381975 A1
(43) Pub. Date: Dec. 19, 2019

(54) MODULE FOR CLEANING AN OPTICAL ELEMENT OR AN OPTICAL ELEMENT PROTECTION DEVICE AND ASSOCIATED DRIVING ASSISTANCE SYSTEM

(71) Applicant: Valeo Systèmes d'Essuyage, Le Mesnil Saint Denis (FR)

(72) Inventors: Gérald Caillot, Le Mesnil Saint Denis (FR); Giuseppe Grasso, Issoire (FR); Jean-François Rousseau, Issoire (FR); Marcel Trebouet, Le Mesnil Saint Denis (FR); Frédéric Bretagnol, Issoire (FR); Jean-Michel Jarasson, Le Mesnil Saint Denis (FR); Frédéric Giraud, Le Mesnil Saint Denis (FR); Mehdi Belhaj, Le Mesnil Saint Denis (FR); Jose Luis Herrada, Le Mesnil Saint Denis (FR)

(73) Assignee: Valeo Systèmes d'Essuyage, Le Mesnil Saint Denis (FR)

(21) Appl. No.: 16/445,993

(22) Filed: Jun. 19, 2019

(30) Foreign Application Priority Data
Jun. 19, 2018 (FR) 1855402

(51) Int. Cl. B60S 1/60; G02B 27/00; B60S 1/56; B60S 1/52

(52) U.S. Cl. CPC B60S 1/60; G02B 27/0006; H04N 5/2254; B60S 1/52; B60S 1/566

(57) ABSTRACT

The subject matter of the present invention is a module (5) for cleaning an optical element protection device (3) intended to equip a motor vehicle, said protection device (3) having a surface of revolution configured to be arranged around the optical element. The cleaning module (5) includes at least one ring (51) configured to surround the protection device (3) and includes at least one wiping structure. The ring (51) is configured to be mobile in relative movement in translation along an axis of revolution (A2) of the ring (51) relative to the protection device (3) such that said at least one wiping structure (53) of the ring (51) is configured to wipe the surface of revolution of the protection device (3).

The present invention relates to the field of driving assistance and in particular to the driving assistance systems installed on some motor vehicles.

A driving assistance system may include at least one optical element. The invention more particularly concerns a module for cleaning a device for protecting an optical element of this kind of driving assistance system. The invention also concerns a cleaning module intended to clean an optical element directly. In fact, some optical elements have no attached protection device.

The optical element of a driving assistance system is configured to emit and/or to capture optical signals in order to determine road scenes or an environment around the motor vehicle. In the case of elements capturing optical signals, such optical elements may for example be video cameras including at least one lens. Also, in the case of elements emitting and capturing optical signals, such optical elements may use a lidar (Light Detection And Ranging) technology.

At present, numerous optical elements equip a large number of motor vehicles in order to facilitate parking them, or again to allow that motor vehicle some autonomy. In this second case, there may be non-limitingly cited line crossing detectors, automatic emergency braking systems, adaptive speed regulators, dead spot detection devices, or again some equipment such as provided with the lidar technology for vehicles, for example autonomous vehicles.

Such optical elements are generally installed on the outside of the motor vehicle, as for example at the level of the roof, the front or rear wings, the wing mirrors, or again the pillars at the sides of the windscreen of the motor vehicle. These optical elements are therefore very exposed to organic and mineral dirt, such as for example dust or insects, and equally to inclement weather that may leave traces of water for example in the field of view and/or of emission of the optical element, which may degrade its correct operability and therefore the correct operability of the driving assistance system.

There are known in the prior art numerous modules for cleaning optical elements such as video cameras to assist with parking. There is known for example from the document U.S. Pat. No. 9,783,167 a cleaning module for spraying a cleaning liquid onto an optical element of a driving assistance system at the level of its field of view. However, after a cleaning operation, residual droplets on the clean surface may interfere with the driving assistance system.

Driving assistance systems increasingly feature a surface of revolution in order to be able to capture road scenes all around the motor vehicle for example, and generally have a relatively small radius of curvature, that is to say a sharp curvature, for reasons of aerodynamics and overall size. There may be cited in particular driving assistance systems utilizing the Lidar technology.

However, the cleaning modules known in the prior art are not suitable for cleaning such surfaces of revolution with small radii of curvature.

The present invention proposes to alleviate, at least partly, the problems of the prior art described above by proposing a cleaning module for effective cleaning of a surface of an optical element or of an optical element protection device used in a driving assistance system, this kind of surface having a small radius of curvature, or a sharp curvature.

Another objective of the present invention, different from the previous objective, is to propose a driving assistance system the cleaning of which is effective and simple to implement when the motor vehicle is moving or stationary.

In order to achieve at least partly at least one of the aforementioned objectives, the present invention consists in a module for cleaning an optical element or an optical element protection device, intended in particular to equip a motor vehicle. The optical element or the protection device has a surface of revolution. If the surface to be cleaned is part of a protection device, the surface of revolution of the latter is configured to be arranged around the optical element.

The cleaning module includes at least one ring configured to surround the surface of revolution of the optical element or of the protection device and includes at least one cleaning structure.

The ring is preferably configured to be mobile with a relative movement in translation along an axis of revolution of the ring relative to the optical element or to the protection device so as to drive movement of the cleaning structure along the surface of revolution.

This kind of cleaning module enables effective cleaning of an optical element or of a protection device surrounding an optical element having a small radius of curvature. In fact, the use of a ring intended to surround the surface of revolution makes it possible to work around constraints linked to the radius of curvature. Also, the presence of a cleaning structure makes it possible to eliminate dust or water droplets that might be deposited on the surface of revolution to be cleaned in order to guarantee good operation of the optical element.

The cleaning module according to the present invention may further include one or more of the following features separately or in combination.

The ring has at least one part of circular arc shape.

In one particular embodiment, the ring has an annular shape.

The ring has an internal surface configured to be disposed facing the surface of revolution to be cleaned.

In one aspect, the cleaning structure includes at least one fluid spraying nozzle configured to spray a cleaning fluid onto the surface of revolution.

The cleaning fluid may be chosen among: compressed air, or a cleaning liquid.

The cleaning fluid may equally be compressed air and cleaning liquid. The compressed air and the cleaning liquid may be sprayed simultaneously. Simultaneous spraying may in particular be effected by different nozzles, one blowing air, the other spraying the liquid. Alternatively, the blowing of compressed air may occur during a first step, followed by a second step of spraying cleaning liquid, or spraying cleaning liquid may occur during a first step, followed by a second step of blowing compressed air.

The at least one fluid spraying nozzle may be separate from the ring.

Alternatively, the ring includes said at least one fluid spraying nozzle.

In one particular embodiment, the cleaning structure includes a wiping structure. This kind of structure has the advantage of enabling mechanical cleaning of the surface of revolution.

In one particular embodiment, the wiping structure includes an O-ring.

In one particular embodiment, the ring may be substantially transparent to the emission and/or reception wavelengths of the optical element.

In a variant, the at least one fluid spraying nozzle may be mounted on the ring, the latter also including the wiping structure.

In this variant, the at least one fluid spraying nozzle and the wiping structure may be disposed adjacent to one another on the internal surface of the ring.

In this variant, the at least one fluid spraying nozzle and the wiping structure may also be disposed in contact with one another or spaced from one another on the internal surface of the ring.

In one aspect, the present invention relates to a module for cleaning an optical element or an optical element protection device, the optical element including at least one sensor and/or at least one optical signal emitter and sensor, intended to equip a motor vehicle. The optical element or the protection device has a surface of revolution. When the surface of revolution is part of the protection device, that surface is configured to be arranged around said at least one sensor and/or at least one optical signal emitter and sensor. The cleaning module includes at least one ring of annular general shape having an axis of revolution, configured to surround the surface of revolution, and at least one cleaning structure, preferably a wiping structure.

The present invention also consists in a driving assistance system, in particular for motor vehicles. The driving assistance system includes at least one optical element and also:
at least one surface of revolution around a first axis of revolution, said surface of revolution being part of a protection device and being configured to be arranged around said at least one optical element or said surface of revolution that is part of the optical element,
an associated cleaning module as described above, including a ring, and
at least one actuator configured to generate relative movement in translation of the surface of revolution and the ring of the cleaning module along a second axis of revolution of the ring.

The driving assistance system may further include one or more of the following features separately or in combination.

In one particular embodiment, the surface of revolution and the ring of the cleaning module have complementary general shapes.

In one aspect, the surface of revolution may have a cylindrical shape and the ring of the cleaning module may have an annular shape.

In this aspect, the first axis of revolution of the protection device or of the optical element and the second axis of revolution of the ring of the cleaning module coincide.

The optical element may be chosen among an optical sensor or an optical sensor coupled to an optical emitter.

In one particular embodiment, the driving assistance system includes lidar technology corresponding to the emission of a laser beam and to the detection of the received echo in order to determine the distance separating the motor vehicle from another object.

In a first aspect, the protection device or the optical element is configured to be fixedly mounted on the motor vehicle and the ring is configured to be mounted mobile relative to the protection device or to the optical element.

In this first aspect, the at least one actuator is configured to drive the ring in movement between:
a retracted position in which the ring is disposed flush with the bodywork element or is accommodated inside the bodywork element, and
a deployed position, in which the ring projects relative to the bodywork element.

In a second aspect, the ring is configured to be fixedly mounted on the motor vehicle and the protection device is configured to be mounted mobile relative to the ring.

In this second aspect, the at least one actuator is configured to drive the protection device in movement between:
an active position, in which the protection device is disposed at least in part outside the bodywork element, and
a passive position in which the protection device is accommodated at least in part inside the bodywork element and/or at least in part facing the ring.

In another aspect, the driving assistance system includes at least two separate protection devices and at least two cleaning modules associated with a respective protection device.

The protection devices may be interconnected by a cap.

The at least one actuator is for example disposed in such a manner as to be able to move the cap in order to control in a synchronized manner the movement in translation of the protection devices.

In this variant, the at least one actuator may be disposed substantially at the centre of the cap.

In this variant, the at least one actuator may be configured to drive the at least two protection devices simultaneously in movement between their active position and their passive position.

The at least one actuator may be chosen among: pneumatic, electric, or again magnetic actuators.

In one aspect, the cleaning structure is configured to be disposed in the field of view of at least one optical element when wiping the surface of revolution of the protection device.

The driving assistance system may further include an electronic control unit configured to trigger a process of cleaning the optical element or of the optical element protection device, said cleaning process including:
at least one first cleaning step during relative movement between the ring and the surface of revolution along the second axis of revolution of the ring in a first direction, and
a second cleaning step during relative movement between the ring and the surface of revolution along the second axis of revolution of the ring in a second direction opposite the first direction.

In one aspect, the process of cleaning the protection device may be triggered when the vehicle is stationary by relative movement of the protection device from its active position to its passive position during the first cleaning step so that the protection device enters at least in part into the bodywork element and then from its passive position to its active position during the second cleaning step so that the protection device returns into its active position.

In another aspect, the process of cleaning the protection device or the optical element may be triggered when the vehicle is moving by relative movement of the ring from its retracted position to its deployed position during the first cleaning step so as to clean for a first time the protection device or the optical element then from its deployed position to its retracted position during the second cleaning step so as to clean for a second time the protection device or the optical element.

The electronic control unit may be configured to control the at least one fluid spraying nozzle in order to execute a step of spraying cleaning fluid onto the optical element or the protection device if the optical element detects dirt.

In one aspect, the step of spraying cleaning fluid is executed at least simultaneously with the first wiping step.

Other features and advantages of the present invention will become more clearly apparent on reading the following description, given by way of nonlimiting illustration, and from the appended drawings, in which:

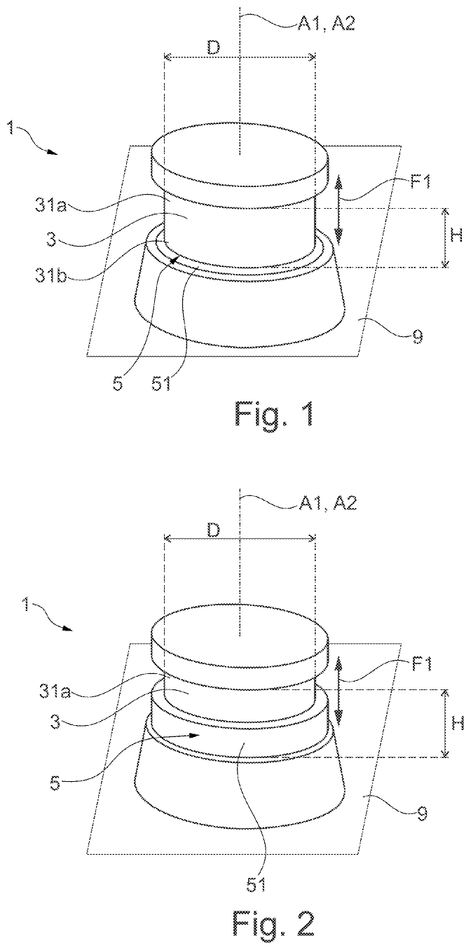

FIG. 1 is a diagrammatic partial perspective view of a driving assistance system,

FIG. 2 is a diagrammatic perspective view of a driving assistance system according to one particular embodiment during a cleaning process,

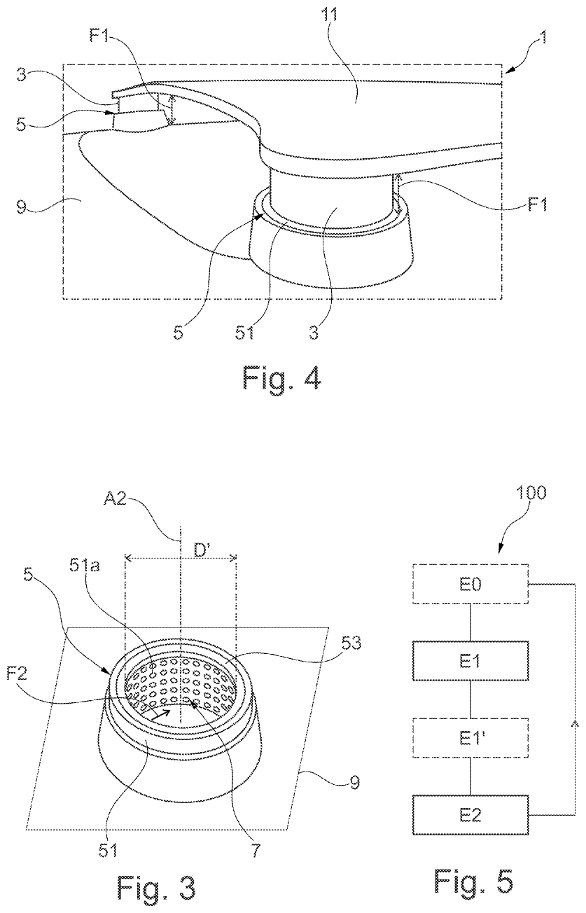

FIG. 3 is a diagrammatic perspective view of a cleaning module of a driving assistance system according to one particular embodiment,

FIG. 4 is a diagrammatic perspective view of a driving assistance system according to a variant of the embodiments from FIGS. 1 and 2, and

FIG. 5 is a diagram showing the various steps of a method of cleaning a protection device of an optical element of the driving assistance system from FIGS. 1, 2 and 4.

Identical elements in the various figures bear the same reference numbers.

The following embodiments are examples. Although the description refers to one or more embodiments, this does not necessarily mean that each reference concerns the same embodiment or that the features apply only to one embodiment. Single features of different embodiments may equally be combined and/or interchanged to provide other embodiments.

In the following description reference is made to first and second ends of the protection device, to first and second axes of revolution, and to first and second wiping/cleaning steps. This is merely indexing for distinguishing and designating similar but not identical elements. Nor does this indexing imply an order in time for assessment of the disposition of the various elements constituting the driving assistance system or again for assessment of the unfolding of a process of cleaning that driving assistance system.

### Driving Assistance System

Referring to FIGS. 1 and 2, there is shown in part a driving assistance system 1 in particular for motor vehicles. The driving assistance system 1 includes:
at least one optical element,
at least one protection device 3,
for each protection device 3, an associated cleaning module 5, and
at least one actuator (not shown).

The optical element may be chosen among an optical sensor, such as a video camera configured to capture and to transmit road scenes for example, or an optical sensor coupled to an optical emitter like a lidar technology for example, corresponding to the emission of a laser beam and to the detection of the received echo in order to determine the distance separating the motor vehicle from another object, or a combination of those elements. The optical element is intended to be accommodated in a corresponding protection device 3.

Also, the driving assistance system 1 may include a plurality of optical elements that may be accommodated in a common protection device 3. The optical elements may be arranged so that their respective fields of view are oriented in different directions in order to capture different road scenes all around the motor vehicle.

Thus the optical elements may have different viewing angles depending on the number and the type of components of the optical element, and the viewing angle of the or each optical element is preferably between 60° and 360° inclusive. With optical elements of this kind, the driving assistance system 1 may equip autonomous vehicles for example.

The protection device 3 has a surface of revolution about a first axis of revolution A1. That surface of revolution is configured to be arranged around the optical element in order to protect the latter from deterioration that it might suffer, in particular by being sprayed with solid elements of mineral or organic origin such as gravel or insects.

The protection device 3 has a cylindrical general shape for example. In this particular embodiment, the protection device 3 has a height H that may for example be between 50 mm and 350 mm inclusive, in particular between 250 mm and 300 mm. Also, the protection device 3 has a diameter D between 60 mm and 210 mm inclusive for example. However, to protect optical elements that are large and/or present in large numbers and protected by a single protection device 3, the protection device 3 could equally have a diameter up to 800 mm. In other variants not represented here the protection device 3 may have other geometrical shapes.

One embodiment of the cleaning module 5 is represented in more detail in FIG. 3. The cleaning module 5 includes at least one ring 51 having a second axis of revolution A2. The ring 51 is configured to surround the protection device 3, as shown in FIGS. 1 and 2. The cleaning module 5 can therefore be adapted to any shape of the surface of revolution of the protection device 3.

In that particular embodiment the protection device 3 and the ring 51 have complementary general shapes. The ring 51 has an internal surface 51a intended to be disposed facing the protection device 3. Also, the first axis of revolution A1 of the protection device 3 and the second axis of revolution A2 of the ring 51 coincide for example.

The cleaning module 5 includes a cleaning structure. That cleaning structure is preferably a wiping structure 53. The wiping structure 53 is provided on the internal surface 51a of the ring 51.

The wiping structure 53 is configured to be disposed in contact with the protection device 3 during at least a part of a process 100 (FIG. 5) of cleaning the latter so as to wipe the surface of revolution of the protection device 3. This kind of cleaning process 100 is described in more detail hereinafter. Wiping of the surface of revolution of the protection device 3 by the wiping structure 53 enables removal of any dirt present on that surface of revolution. The wiping may be carried out during relative movement between the ring 51 and the protection device 3, more particularly relative movement in translation along the second axis of revolution A2 of the ring 51 as explained hereinafter. Thus the protection device 3 can be cleaned effectively whatever the shape of its surface of revolution so that the driving assistance system 1 continues to operate correctly.

In the particular embodiments from FIGS. 1 to 3, the ring 51 has at least one part of circular arc shape, and more particularly annular shape, in order to be able to adapt to the cylindrical shape of the protection device 3. The ring 51 more particularly has a diameter D′. In order to enable effective cleaning of the protection device 3 whilst limiting stresses during the relative movement between the ring 51 and the protection device 3, the diameter D′ of the ring 51 is significantly greater than the diameter D of the protection device 3. The diameter D′ of the ring 51 is more particularly sufficient to ensure contact between the wiping structure 53 and the surface of revolution of the protection device 3. Effective cleaning of the protection device 3 is therefore possible whatever its radius of curvature, and more particularly if that radius of curvature is small.

The wiping structure 53 has a general shape complementary to the shape of the surface of revolution of the protection device 3 that this wiping structure 53 is called upon to wipe during the cleaning process 100 described hereinafter. In the particular embodiment from FIG. 3, the wiping structure 53 includes an O-ring. In other variants not represented here, the wiping structure 53 may be made from other materials or have a different shape.

The wiping structure 53 is intended to be disposed in the field of view of the at least one optical element during wiping of the surface of revolution of the protection device 3. The wiping structure 53 therefore cleans the external surface of the protection device 3, preferably over the whole of the field of view of the optical element in order to enable the driving assistance system 1 to operate correctly. The wiping structure 53 may therefore extend over part of the internal surface 51a of the ring 51. In the particular embodiment from FIG. 3, the wiping structure 53 extends all around the perimeter of the internal surface 51a of the ring 51 in order to be able to clean the whole of the perimeter of the protection device 3 whether the optical element has an angle of view of 360° or not.

In the particular embodiment from FIG. 1, the cleaning module 5, and more particularly the ring 51, is configured to be disposed flush with the bodywork element 9 of the motor vehicle from which the protection device 3 projects.

The cleaning module 5 may include a cleaning structure including at least one fluid spraying nozzle 7 configured to spray a cleaning fluid onto the surface of revolution of the protection device 3.

The cleaning structure preferably includes a wiping structure 53 and at least one fluid spraying nozzle 7, as represented in FIG. 3.

In fact, in the case of tenacious dirt or dirt encrusted on this surface of revolution, the mechanical action linked to the wiping of the surface of revolution of the protection device by the wiping structure 53 alone may not be sufficient. It may therefore be possible to have recourse to the use of a cleaning fluid such as compressed air or a cleaning liquid in order to contribute to detaching this tenacious or encrusted dirt from the external surface of the protection device 3. More particularly, using compressed air enables such dirt to be detached thanks to the intensity of the flow of air blown onto the surface of revolution of the protection device 3 and the use of cleaning liquid for wetting this dirt in order to facilitate its detachment from this surface of revolution during wiping of the latter by the wiping structure 53.

The blowing of compressed air and the spraying of cleaning liquid may be simultaneous, or the blowing of compressed air may occur during a first step, followed by a second step of spraying cleaning liquid, or the spraying of cleaning liquid may occur during a first step, followed by a second step of blowing compressed air.

In the particular embodiment from FIG. 3, the at least one fluid spraying nozzle 7 is incorporated in the ring 51. The at least one fluid spraying nozzle 7 is disposed in such a manner as to spray cleaning fluid in the direction of the second axis of revolution A2 of the ring 51, as represented by the arrow F2.

In this particular embodiment, the ring 51 includes at least one fluid spraying nozzle 7. However, in a variant not represented here the at least one fluid spraying nozzle 7 may be mounted on the ring 51, i.e. may be a supplementary structure installed inside the ring 51.

Also, in this particular embodiment the at least one fluid spraying nozzle 7 and the wiping structure 53 are disposed adjacent to, that is to say in line with, one another on the internal surface 51a of the ring 51, being directly in contact or not.

In an alternative not represented here, the at least one fluid spraying nozzle 7 may be separate from the ring 51. More particularly, the at least one fluid spraying nozzle 7 may be disposed on the exterior of the motor vehicle and oriented in such a manner as to be able to spray cleaning fluid onto the surface of revolution of the protection device 3 during the cleaning process 100.

Also, the at least one actuator is configured to generate the relative movement in translation between the ring 51 of the cleaning module 5 and the protection device 3. This relative movement in translation is in a direction parallel to the second axis of revolution A2 of the ring 51. This relative movement in translation enables execution of the process 100 (described with reference to FIG. 5) of cleaning the protection device 3. More particularly, the relative movement in translation between the ring 51 and the protection device 3 is in the direction of the arrow F1 represented in FIGS. 1 and 2. During this relative movement, the wiping structure 53 therefore wipes the surface of revolution of the protection device 3 by also moving parallel to the first axis of revolution A1 of the protection device 3. Such movement in translation accommodates the radius of curvature of the surface of revolution of the protection device 3 and therefore guarantees effective cleaning of the protection device 3.

The actuator may be chosen among pneumatic actuators, electric actuators, or again magnetic actuators. Such actuators are of relatively low cost and relatively small overall size and can be easily integrated into the motor vehicle.

### First Embodiment

In a first embodiment, the protection device 3 is mobile in translation in the direction of the arrow F1 whereas the ring 51 of the cleaning module 5 is fixed. More particularly, in the embodiment from FIG. 1 the ring 51 is for example disposed flush with the bodywork element 9.

In this particular first embodiment, the protection device 3 can be moved between an active position (FIG. 1) and a passive position (not represented), in particular by the actuator when the cleaning process 100 is executed.

In the active position, the protection device 3 is disposed at least in part outside the bodywork element 9, as represented in FIG. 1. The optical element disposed inside the protection device 3 is able to capture road scenes or scenes of the environment around the motor vehicle when the protection device 3 is in the active position. More particularly, the protection device 3 may project from the bodywork element 9 of the motor vehicle. The protection device 3 therefore has a first end 31a and a second end 31b opposite the first end 31a. This second end 31b is disposed as close as possible to the bodywork element 9. The first end 31a projects relative to the bodywork element 9, and extends at a distance from the second end 31b.

When the protection device 3 is in the passive position, it is accommodated at least in part inside the bodywork element 9 and/or at least in part facing the ring 51. When the protection device 3 is in the passive position, capture of road scenes around the motor vehicle by the optical element accommodated inside the protection device 3 is no longer possible.

This first embodiment is therefore particularly suitable for executing the cleaning process 100 when the motor vehicle is stationary, for example at a traffic light or parked.

### Second Embodiment

In a second embodiment, represented in FIG. 2, the protection device 3 is intended to be fixedly mounted and at least one element of the cleaning module 5 is mounted mobile in translation in the direction of the arrow F1. For example, the ring 51 is mounted mobile in translation in the direction of the arrow F1.

The protection device 3 may be fixed by being disposed at least in part outside the bodywork element 9 of the motor vehicle so that the optical element disposed inside the latter is able to capture road scenes or scenes of the environment around the motor vehicle. More particularly, the protection device 3 may project from the bodywork element 9 of the motor vehicle. The protection device 3 therefore has a first end 31a and a second end 31b opposite the first end 31a. This second 31b is disposed as close as possible to the bodywork element 9. The first end 31a is disposed to project relative to the bodywork element 9 and extends at a distance from the second end 31b.

In this second embodiment, the ring 51 can be moved between a retracted position and a deployed position, in particular by the actuator when the cleaning process 100 is executed. When the ring 51 is in the retracted position, it is for example flush with the bodywork element 9 or it may be accommodated inside the bodywork element 9. When the ring 51 is in its deployed position, it projects from the bodywork element 9. More particularly, the end of travel of its deployed position is delimited by the first end 31a of the protection device 3 that can for example form an abutment.

When the ring 51 is moved between the retracted position and the deployed position it therefore wipes the whole of the outside surface of the protection device 3.

In this second embodiment, the ring 51 and the wiping structure 53 may be substantially transparent to the emission and/or reception wavelengths of the optical element, which corresponds to a lidar technology optical element. This is particularly advantageous if the wiping structure 53 wipes the surface of revolution of the protection device 3, the optical element continuing to function. It is therefore possible to execute the cleaning process 100 when the motor vehicle is moving or stationary without compromising the correct operation of the driving assistance system 1. In fact, the movement of the ring 51 over the height H of the protection device 3 during the cleaning operation 100 does not compromise the reception or the emission of the optical signals from the optical element constituting the driving assistance system 1.

### Variant of the First or Second Embodiment

In the variant represented in FIG. 4, the driving assistance system may further include at least two protection devices 3 as described with reference to FIGS. 1 and 2. The protection devices 3 are separate and arranged at a distance from one another and each aims to protect an optical element or a set of optical elements. These protection devices 3 may be interconnected by a cap 11. In this variant, the driving assistance system 1 also includes a cleaning module 5 associated with each protection device 3.

As indicated above, each cleaning module 5 may include a cleaning structure having a wiping structure 53 and/or at least one fluid spraying nozzle 7. These cleaning modules 5 preferably have the same structure as the cleaning module 5 shown in and described with reference to FIG. 3.

In the variant of the first embodiment, the rings 51 are fixed, the protection devices 3 are mobile in translation, and the actuator may be disposed in such a manner as to move the cap 11 in order to drive the movement of the protection devices 3 in a synchronized manner or even simultaneously. The protection devices 3 may be moved in translation along an axis parallel to the second axis of revolution A2 of each ring 51, that is to say in the direction of the arrow F1, between an active position and a passive position. As before, the active position of the protection devices 3 corresponds to a disposition thereof at least in part outside the bodywork element 9, and the passive position corresponds to a disposition thereof at least in part inside the bodywork element 9 and/or at least in part facing the ring 51.

The actuator may in particular be disposed substantially at the centre of the cap 11 so as to enable simultaneous movement of the protection devices 3 between their active position and their passive position.

The process 100 for cleaning the protection device 3 may be executed when the motor vehicle is stationary.

In the variant of the second embodiment the protection device 3 and the cap 11 may be fixed, the rings 51 mobile, and the actuator configured to move the rings 51 of the cleaning modules 5 relative to the protection devices 3 along the second axis of revolution A2 of the ring 51 so as to execute the cleaning process 100 as described hereinafter.

The driving assistance system 1 (represented in FIGS. 1, 2 and 4) may further include an electronic control unit (not represented here). The electronic control unit is configured to trigger the process 100 for cleaning the or each protection device 3. The electronic control unit may be connected to the at least one optical element, which may be configured to enable detection of dirt on the at least one protection device 3.

### Cleaning Process

Referring to FIG. 5, there is represented diagrammatically a diagram showing the various steps executed during a process 100 of cleaning a protection device 3 as described above with reference to FIGS. 1, 2 and 4.

The cleaning process 100 includes at least two wiping steps E1, E2 effected by relative movement between the protection device 3 and the ring 51 (FIGS. 1, 2 and 4) of an associated cleaning module 5. The relative movement is in a direction parallel to the second axis of revolution A2 of the ring 51. During a first wiping step E1, the movement may be effected in a first direction. During a second wiping step E2, the movement may be effected in a second direction opposite the first direction.

For example, the first wiping step E1 corresponds to the movement of the protection device 3 from its active position to its passive position, or to the movement of the ring 51 from its retracted position to its deployed position. Conversely, the second wiping step E2 corresponds to the movement of the protection device 3 from its passive position to its active position, or to the movement of the ring 51 from its deployed position to its retracted position. During the cleaning process 100 the surface of revolution of the protection device 3 is therefore wiped at least twice by the wiping structure 53 (FIG. 3). Such wiping by a return movement cleans the protection device 3 without necessarily requiring the use of a cleaning fluid, which among other things makes it possible to limit the operating costs of the at least one cleaning module 5.

The cleaning process 100 may optionally include a step E0 of detecting the presence of dirt on the surface of revolution of the protection device 3. This detection step E0 may be carried out before the first wiping step E1. The detection step E0 may be executed by an optical element. The images captured by the optical element may for example be processed by the electronic control unit, which is able to trigger the cleaning process 100 or not as a function of the result of processing the images captured by the electronic control unit.

Alternatively or additionally, a detection step E0 may be executed after the first and second wiping steps E1 and E2. This detection step E0 enables detection of the presence of any dirt on the surface of revolution of the protection device 3 after the second wiping step E2. If dirt is still detected, the electronic control unit can command repetition of the cleaning process 100. That repetition may include an additional step E1′ of spraying cleaning fluid onto the external surface of the protection device 3. To this end, the electronic control unit is configured to control the at least one fluid spraying nozzle 7 in order to execute this step E1′ of spraying cleaning fluid. This step E1′ of spraying cleaning fluid may for example be carried out at the same time as the first wiping step E1.

If dirt is still detected on the surface of revolution of the protection device 3 during the detection step E0 following a first iteration of the cleaning process 100, the electronic control unit is therefore able to trigger repetition of that cleaning process 100, possibly employing the step E1′ of spraying cleaning fluid between the first and second wiping steps E1 and E2 in order to facilitate elimination of the dirt remaining on the surface of revolution of the protection device 3.

The cleaning process 100 described here may in particular be executed when the driving assistance system 1 includes the at least one cleaning module 5 described with reference to FIGS. 1 to 3. Alternatively, if the fluid spraying nozzle 7 is separate from the ring 51, the first wiping step E1 and the cleaning fluid spraying step E1′ may be interchanged.

Also, the cleaning process 100 may be repeated several times during a cleaning cycle, and in particular when the first and second wiping steps E1 and E2 are not able to produce a satisfactory state of cleanliness of the protection device 3.

This kind of cleaning process 100 therefore does not necessitate the intervention of a user of the motor vehicle in order for the driving assistance system 1 to continue to operate correctly. This driving assistance system 1 can therefore equip autonomous vehicles for example.

Alternatively, when the cleaning structure of the cleaning module includes only one or more fluid spraying nozzles 7 carried by the ring 51, for example, the steps E1 and E2 described above may be cleaning steps during which the at least one fluid spraying nozzle 7 sprays the external surface of the protection device 3 with the fluid.

The effective cleaning of a driving assistance system 1 including a protection device 3 of an optical element having a small radius of curvature is therefore possible thanks to the cleaning module 5 described above. More particularly, the wiping of the surface of revolution of the protection device 3 by the wiping structure 53 on the ring 51 of the cleaning module 5 around the surface of revolution during relative movement of the protection device 3 with respect to the ring 51 enables effective cleaning of that surface of revolution without having to take account of the radius of curvature of that surface of revolution.

The particular examples described above are given by way of nonlimiting illustration. In fact, the person skilled in the art could in particular use shapes for the surface of revolution of the protection device 3 or for the ring 51 other than those described above without departing from the scope of the present invention.

Likewise, some optical elements of the driving assistance system have no protection device, in which case the surface to be cleaned is directly that of the optical element, which also has a surface of revolution.

1. A module for cleaning an optical element or an optical element protection device to equip a motor vehicle, said optical element or said protection device having a surface of revolution, the cleaning module comprising:
at least one ring having at least one circular arc shape part configured to surround the surface of revolution of the optical element or of the protection device; and
at least one cleaning structure.

2. The cleaning module according to claim 1, wherein the cleaning structure includes at least one fluid spraying nozzle configured to spray a cleaning fluid onto the surface of revolution.

3. The cleaning module according to claim 2, wherein the ring includes said at least one fluid spraying nozzle.

4. The cleaning module according to claim 1, wherein the cleaning structure includes a wiping structure, the wiping structure including an O-ring.

5. The cleaning module according to claim 1, wherein the ring is configured to be mobile with a relative movement in translation along an axis of revolution of the ring with respect to the optical element or to the protection device so as to drive movement of the cleaning structure along the surface of revolution.

6. A driving assistance system for motor vehicles, comprising:
at least one optical element;
at least one surface of revolution about a first axis of revolution, said surface of revolution being part of a protection device and being configured to be arranged around said at least one optical element or said surface of revolution that is part of the optical element;
an associated cleaning module according to claim 1, including a ring; and
at least one actuator configured to generate relative movement in translation between the surface of revolution and the ring of the cleaning module along a second axis of revolution of the ring.

7. The driving assistance system according to claim 6, wherein the surface of revolution and the ring of the cleaning module have complementary general shapes.

8. The driving assistance system according to claim 6, wherein the first axis of revolution of the protection device or of the optical element and the second axis of revolution of the ring of the cleaning module coincide.

9. The driving assistance system according to claim 6, wherein the protection device or the optical element are configured to be fixedly mounted on the motor vehicle and the ring is configured to be mounted mobile relative to the protection device or to the optical element.

10. The driving assistance system according to claim 6, wherein the ring is configured to be fixedly mounted on the motor vehicle and the protection device is configured to be mounted mobile relative to the ring.

11. The driving assistance system according to claim 10, further comprising:
at least two separate protection devices; and
at least two cleaning modules respectively associated with one of the protection devices, said protection devices being interconnected by a cap,
wherein the at least one actuator is disposed in such a manner as to be able to move the cap in order to drive in a synchronized manner the movement in translation of the protection devices.

12. The driving assistance module according to claim 6, further comprising:
an electronic control unit configured to trigger a process of cleaning the optical element or the optical element protection device, said cleaning process including:
at least one first cleaning step during relative movement between the ring and the surface of revolution along the second axis of revolution of the ring in a first direction, and
a second cleaning step during relative movement between the ring and the surface of revolution along the second axis of revolution of the ring in a second direction opposite the first direction.

13. The driving assistance system according to claim 12, wherein the cleaning structure includes at least one fluid spraying nozzle configured to spray a cleaning fluid onto the surface of revolution, and wherein the electronic control unit is configured to control the at least one fluid spraying nozzle to execute a step of spraying cleaning fluid onto the optical element or the protection device when dirt is detected by the optical element.
